(19) United States
(12) Patent Application Publication
(10) Pub. No.: US 2018/0260357 A1
(43) Pub. Date: Sep. 13, 2018

(54) I2C CLOCK STRETCH OVER I3C BUS

(71) Applicant: QUALCOMM Incorporated, San Diego, CA (US)

(72) Inventors: Yossi Amon, Kiryat Tivon (IS); Lior Amarilio, Yokneam (IS); Ofer Rosenberg, Ramot Menashe (IS)

(21) Appl. No.: 15/453,678

(22) Filed: Mar. 8, 2017

(51) Int. Cl. G06F 13/42; G06F 13/364; G06F 13/40

(52) U.S. Cl. CPC G06F 13/4291; G06F 13/404; G06F 13/364

(57) ABSTRACT

Systems, methods, and apparatus are described that enable an I3C master device to support I2C clock stretch used by I2C devices connected to an I3C bus. A method performed at a master device includes enabling a line driver to drive a clock wire of the serial bus in accordance with a clock signal and when the master device is configured for a first mode of operation, enabling the line driver to drive the clock wire to a first voltage level when the clock signal is in a first signaling state and when the master device is configured for a second mode of operation, and disabling the line driver when the clock signal is in a second signaling state in the second mode of operation. A resistor pulls the clock wire to a second voltage level when the clock signal is in the second signaling state.

### TECHNICAL FIELD

The present disclosure relates generally to an interface between processing circuits and peripheral devices and, more particularly, to support clock stretch on a serial bus operated in accordance with advance protocols.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

In another example, the protocols used on an I3C bus derives certain implementation aspects from the I2C protocol. The I3C bus are defined by the Mobile Industry Processor Interface Alliance (MIPI). Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation. Other protocols, such as the I3C protocol, can increase available bandwidth on the serial bus through higher transmitter clock rates, by encoding data in signaling state of two or more wires, and through other encoding techniques. Certain aspects of the I3C protocol are derived from corresponding aspects of the I2C protocol, and the I2C and I3C protocols can coexist on the same serial bus.

Certain legacy I2C devices operate in a manner that renders them incompatible with I3C protocols. For example, protocols governing I2C bus operations support clock stretch by slave devices. The clock stretch feature may be used for flow control, whereby a slave device can postpone data transfers by holding the clock in a low state until its internal logic is ready to handle the data transfer. I3C bus protocols do not accommodate clock stretch in I2C modes of operation. The ability to support both I2C legacy devices and I3C devices on the same bus is limited by the restriction on use of clock stretch. This limitation reduces the availability of I2C devices that do not rely of clock stretch for flow control.

### SUMMARY

Certain aspects of the disclosure relate to systems, apparatus, methods and techniques that enable an I3C master device to support I2C clock stretch used by I2C devices connected to an I3C bus.

In various aspects of the disclosure, a method performed at a master device coupled to a serial bus includes enabling a line driver to actively drive a clock wire of the serial bus between two signaling states in accordance with a clock signal and when the master device is configured for a first mode of operation, enabling the line driver to actively drive the clock wire to a first voltage level when the clock signal is in a first signaling state and when the master device is configured for a second mode of operation, and disabling the line driver when the clock signal is in a second signaling state and when the master device is configured for a second mode of operation. A resistor pulls the clock wire to a second voltage level when the clock signal is in the second signaling state and when the master device is configured for the second mode of operation.

In some aspects, the method includes providing a feedback signal representative of the signaling state of the clock wire, and modifying the clock signal when the feedback signal indicates that the clock wire is in the first signaling state while the line driver is disabled. Modifying the clock signal includes suppressing the clock signal while the feedback signal indicates that the clock signal is in the first signaling state and while the line driver is disabled, refraining from driving the clock wire for a period of time associated with a pulse width defined by a protocol controlling communication on the serial bus after the feedback signal indicates that the clock signal has transitioned to the second signaling state, and enabling the line driver to actively drive the clock wire to the first voltage level when the clock signal is in the first signaling state and when the period of time has expired. The feedback signal may be provided by a line receiver coupled to the clock wire.

In one example, the method includes using an enable signal derived from the clock signal to control enablement of the line driver when the master device is configured for a second mode of operation.

In one example, the method includes closing a switch that couples the clock wire to a voltage source through the resistor when the master device is configured for the second mode of operation.

The line driver may include a push-pull driver. The serial bus may be operated in accordance with an I3C protocol in the first mode of operation, and in accordance with an I2C protocol in the second mode of operation.

In various aspects of the disclosure, an apparatus includes a line driver coupled to a first wire of a multi-wire serial bus, a clock generator circuit configured to provide a clock signal configured to control data transmissions on the multi-wire serial bus, and a first multiplexer responsive to a mode select signal and configured to provide an output enable signal to the line driver. In a first mode, the line driver is enabled and actively drives the first wire of the serial bus between two signaling states in accordance with the clock signal, and in a second mode the line driver is switched between an active mode and a high-impedance mode based on signaling state of the clock signal. The apparatus may include a switch responsive to the mode select signal. The switch couples the first wire of the serial bus to a pull-up voltage resistor in the second mode. The apparatus may include a second multiplexer responsive to the mode select signal and configured to provide the clock signal to the line driver in the first mode, and to provide a low voltage level to the line driver in the second mode.

In certain aspects, the apparatus may include a receiver coupled to the first wire of the serial bus and configured to providing a feedback signal representative of the signaling state of the first wire of the serial bus. The clock generator circuit may be configured to modify the clock signal when the feedback signal indicates that the first wire of the serial bus is in a first signaling state corresponding to the low voltage level while the line driver is disabled. The clock generator circuit may be configured to modify the clock signal by suppressing the clock signal while the feedback signal indicates that the first wire of the serial bus is in the first signaling state while the line driver is disabled, refraining from driving the first wire of the serial bus for a period of time associated with a pulse width defined by a protocol controlling communication on the serial bus after the feedback signal indicates that the first wire of the serial bus has transitioned from the first signaling state, and enabling the line driver to actively drive the first wire of the serial bus to the low voltage level when the clock signal is in the first signaling state and when the period of time has expired. In one example, the line driver may be a push-pull driver.

In one aspect, the serial bus is operated in accordance with an I3C protocol in the first mode, and operated in accordance with an I2C protocol in the second mode.

In various aspects of the disclosure, an apparatus includes means for providing a clock signal configured to control timing of data transmissions on a serial bus, means for controlling drive state of a line driver coupled to a clock wire of the serial bus. The means for controlling the drive state of the line driver may be configured to enable the output of the line driver when the clock signal is in a first signaling state and when the clock signal is in a second signaling state while the apparatus is configured for a first mode of operation, enable the output of the line driver when the clock signal is in the first signaling state and when the master device is configured for a second mode of operation, and disable the output of the line driver when the clock signal is in the second signaling state and when the master device is configured for the second mode of operation. The line driver may be configured to actively drive the clock wire to a first voltage level when the output of the line driver is enabled and the clock signal is in the first signaling state. The apparatus may include means for pulling the clock wire to a second voltage level when the output of the line driver is disabled.

In certain aspects, the apparatus includes means for providing a feedback signal representative of the signaling state of the clock wire. The means for providing a clock signal may be configured to modify the clock signal when the feedback signal indicates that the clock wire is in the first signaling state and when the line driver is disabled. The means for providing a clock signal may be configured to modify the clock signal by suppressing the clock signal while the feedback signal indicates that the clock signal is in the first signaling state and while the line driver is disabled, refraining from driving the clock wire for a period of time associated with a pulse width defined by a protocol controlling communication on the serial bus after the feedback signal indicates that the clock signal has transitioned to the second signaling state, and enabling the line driver to actively drive the clock wire to the first voltage level when the clock signal is in the first signaling state and when the period of time has expired. The feedback signal may be provided by a line receiver coupled to the clock wire.

In one aspect, the means for controlling the drive state of the line driver is configured to use an enable signal derived from the clock signal to control enablement of the line driver when the master device is configured for a second mode of operation.

In one aspect, the means for pulling the clock wire to the second voltage level may include a resistor, and a switch that couples the clock wire to a voltage source through the resistor when the master device is configured for the second mode of operation. In some examples, the line driver includes a push-pull driver.

In one aspect, the serial bus may be operated in accordance with an I3C protocol in the first mode of operation. The serial bus may be operable in accordance with an I2C protocol in the second mode of operation.

In various aspects of the disclosure, a processor readable storage medium may have code stored thereon that is executable by a processor. The code may include instructions that cause the processor to enable a line driver to actively drive a clock wire of the serial bus between two signaling states in accordance with a clock signal and when the master device is configured for a first mode of operation, enable the line driver to actively drive the clock wire to a first voltage level when the clock signal is in a first signaling state and when the master device is configured for a second mode of operation, and disable the line driver when the clock signal is in a second signaling state and when the master device is configured for a second mode of operation. A resistor may be employed to pull the clock wire to a second voltage level when the clock signal is in the second signaling state and when the master device is configured for the second mode of operation.

In certain aspects, the code includes instructions for causing a feedback signal representative of the signaling state of the clock wire to be provided, and causing the clock signal to be modified when the feedback signal indicates that the clock wire is in the first signaling state while the line driver is disabled. The code may include instructions for causing the clock signal to be suppressed while the feedback signal indicates that the clock signal is in the first signaling state and while the line driver is disabled, refraining from driving the clock wire for a period of time associated with a pulse width defined by a protocol controlling communication on the serial bus after the feedback signal indicates that the clock signal has transitioned to the second signaling state, and enabling the line driver to actively drive the clock wire to the first voltage level when the clock signal is in the first signaling state and when the period of time has expired.

In one aspect, the feedback signal is provided by a line receiver coupled to the clock wire.

In one aspect, the code includes instructions for using an enable signal derived from the clock signal to control enablement of the line driver when the master device is configured for a second mode of operation.

In one aspect, the code includes instructions for closing a switch that couples the clock wire to a voltage source through the resistor when the master device is configured for the second mode of operation.

### BRIEF DESCRIPTION OF THE DRAWINGS

FIG. 1 illustrates an apparatus employing a data link between IC devices that is selectively operated according to one of plurality of available standards.

FIG. 2 illustrates a communication link in which a configuration of devices are connected using a serial bus.

FIG. 3 illustrates certain aspects of an apparatus that includes multiple devices connected to a serial bus.

FIG. 4 illustrates a communication link in which multiple devices are connected using a serial bus.

FIG. 5 illustrates certain aspects of the timing relationship between SDA and SCL wires on a conventional I2C bus.

FIG. 6 includes a timing diagram that illustrates signaling on a serial bus when the serial bus is operated in a single data rate (SDR) mode of operation defined by I3C specifications.

FIG. 7 is a timing diagram illustrating the effect of clock stretch in an I2C bus.

FIG. 8 illustrates certain aspects of an I3C master device that has been adapted according to certain aspects disclosed herein.

FIG. 9 is a flowchart that illustrates a process for operating clock generation and transmission circuits in an interface of an I3C master device that has been adapted in accordance with certain aspects disclosed herein.

FIG. 10 includes timing diagrams that illustrate clock timing when a serial bus is operated in I3C and I2C modes in accordance with certain aspects disclosed herein.

FIG. 11 is a block diagram illustrating an example of an apparatus employing a processing circuit that may be adapted according to certain aspects disclosed herein.

FIG. 12 is a flowchart illustrating a flow-control process that may be performed at a sending device coupled to a serial bus in accordance with certain aspects disclosed herein.

FIG. 13 illustrates a hardware implementation for a transmitting apparatus adapted to respond to a provide a flow control capability in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoC and other IC devices often employ a serial bus to connect application processor or other host device with modems and other peripherals. The serial bus may be operated in accordance with specifications and protocols defined by a standards body. The serial bus may be operated in accordance with I2C or I3C standards or protocols that define timing relationships between signals and transmissions. I3C master devices may be adapted according to certain aspects disclosed herein to support clock stretch used by legacy I2C slave devices to implement flow control.

The conventional I2C protocols provides for data transmission using open-drain line drivers that permit a limited degree of feedback from a receiver. For example, the ACK/NACK bit that follows every byte (8 bits) of data transmitted over an I2C serial bus may be used to signal that an error has occurred and may lead to termination of the current transaction. In the I2C context, data is driven using open-drain mode line drivers and the receiver can control the signaling state of the ACK/NACK bit to signal the sender that the transmission should be terminated. In the I2C example, the receiver may be a slave device when a master device is performing a write, and the receiver may be a master device when the master device is performing a read from a slave device. An I2C master device may drive a clock line using an open-drain line driver, enabling a slave device to hold the clock line at low-voltage state in order to suspend transmissions.

In accordance with certain aspects disclosed herein, an I3C master device may be adapted to emulate open-drain driving of the clock line, enabling coexistence with certain legacy I2C devices that employ clock stretching.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

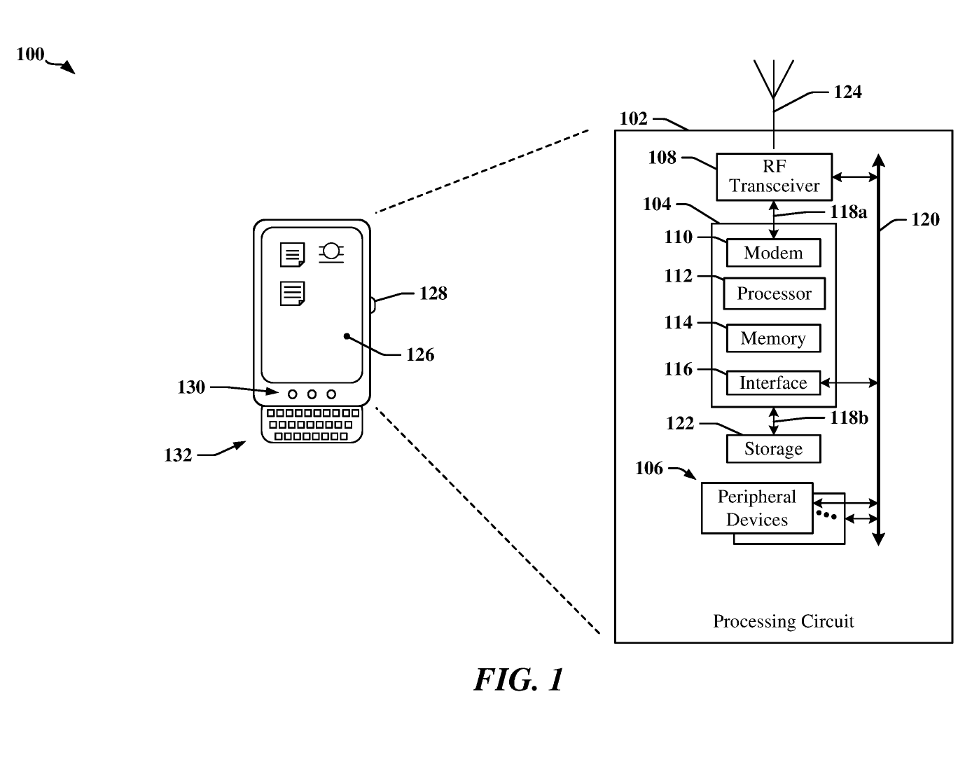

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

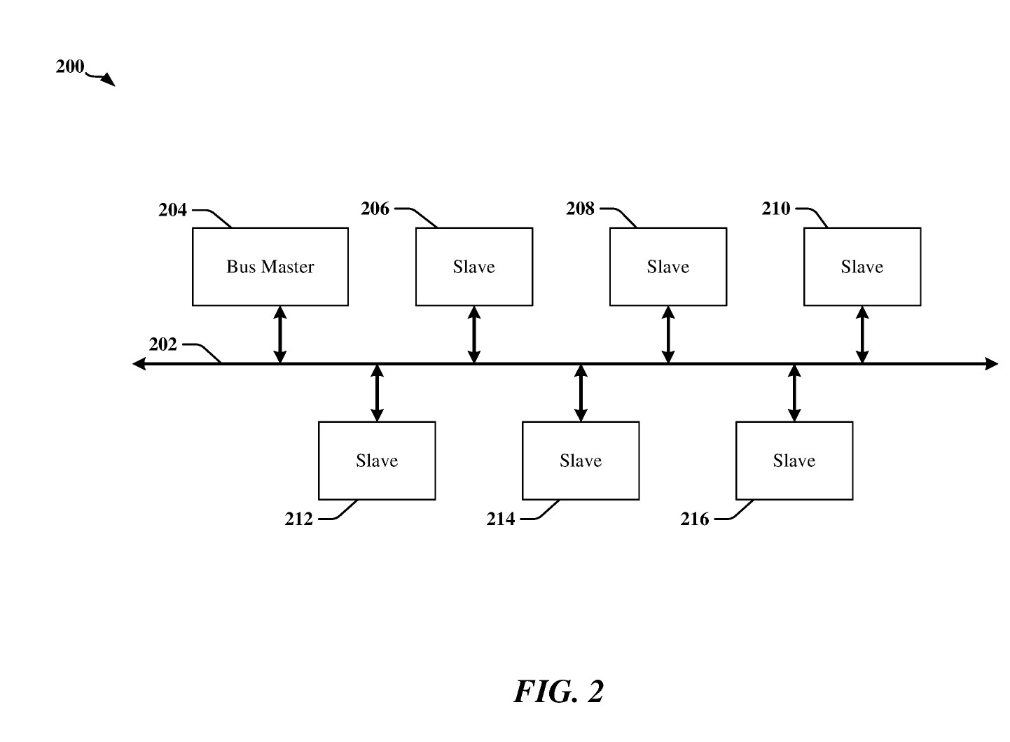

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

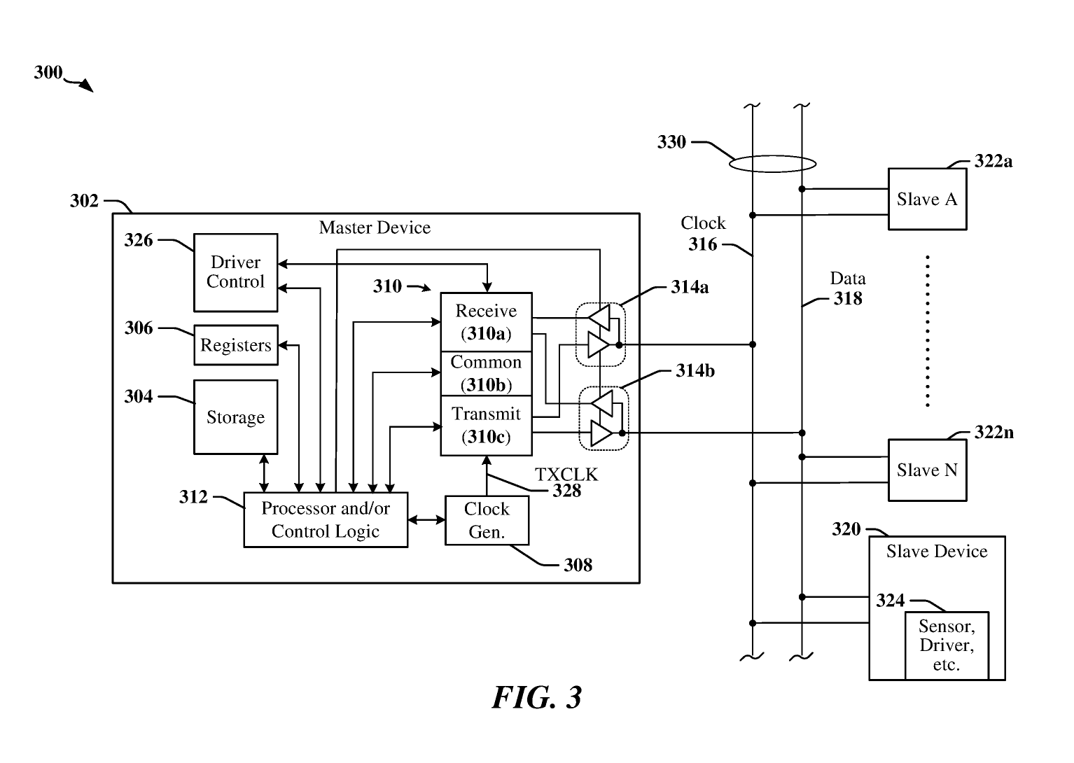

FIG. 3 illustrates certain aspects of an apparatus 300 that includes multiple devices 302, 320 and 322a-322n connected to a serial bus 330. The serial bus 330 may include a first wire 316 that carries a clock signal in certain modes of operation while a second wire 318 carries a data signal. In other modes of operation, data may be encoded in multi-bit symbols, where each bit of the symbol controls signaling state of one of the wires 316, 318. The devices 302, 320 and 322a-322n may include one or more semiconductor IC devices, such as an applications processor, SoC or ASIC. Each of the devices 302, 320 and 322a-322n may include, support or operate as a modem, a signal processing device, a display driver, a camera, a user interface, a sensor, a sensor controller, a media player, a transceiver, and/or other such components or devices. Communications between devices 302, 320 and 322a-322n over the serial bus 330 is controlled by a bus master 302. Certain types of bus can support multiple bus masters 302.

The apparatus 300 may include multiple devices 302, 320 and 322a-322n that communicate when the serial bus 330 is operated in accordance with I2C, I3C or other protocols. At least one device 320, 322a-322n may be configured to operate as a slave device on the serial bus 330. In one example, a slave device 320 may be adapted to provide a sensor control function 324. The sensor control function 324 may include circuits and modules that support an image sensor, and/or circuits and modules that control and communicate with one or more sensors that measure environmental conditions. The master device 302 may include configuration registers 306 and/or other storage 304, control logic 312, a transceiver 310, line drivers/receivers 314a and 314b and driver control circuits and modules 326. In one example, the driver control circuits and modules 326 operate independently and may include a processing circuit such as a state machine, sequencer, signal processor or general-purpose processor. In another example, the driver control circuits and modules 326 may cooperate with the control logic 312. The control logic 312 may include a processing circuit such as a state machine, sequencer, signal processor or general-purpose processor. The transceiver 310 may include a receiver 310a, a transmitter 310c and common circuits 310b, including timing, logic and storage circuits and/or devices. In one example, the transmitter 310c encodes and transmits data based on timing provided by a clock generation circuit 308 that produces a transmitter clock 328 that may be used to control data transmission on the serial bus 330 in accordance with one or more communication protocols. The driver control circuits and modules 326 may be provided or adapted in accordance with certain aspects disclosed herein to manage and control the operation of the transceiver 310, including output state of the line drivers/receivers 314a and 314b.

Two or more of the devices 302, 320 and/or 322a-322n may be adapted according to certain aspects and features disclosed herein to support a plurality of different communication protocols over a common bus, which may include an SMBus protocol, an SPI protocol, an I2C protocol, and/or an I3C protocol. In some examples, devices that communicate using one protocol (e.g., an I2C protocol) can coexist on the same serial bus with devices that communicate using a second protocol (e.g., an I3C protocol). In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 330, in addition to data formats and aspects of bus control. In some aspects, the I2C and I3C protocols may define direct current (DC) characteristics affecting certain signal levels associated with the serial bus 330, and/or alternating current (AC) characteristics affecting certain timing aspects of signals transmitted on the serial bus 330.

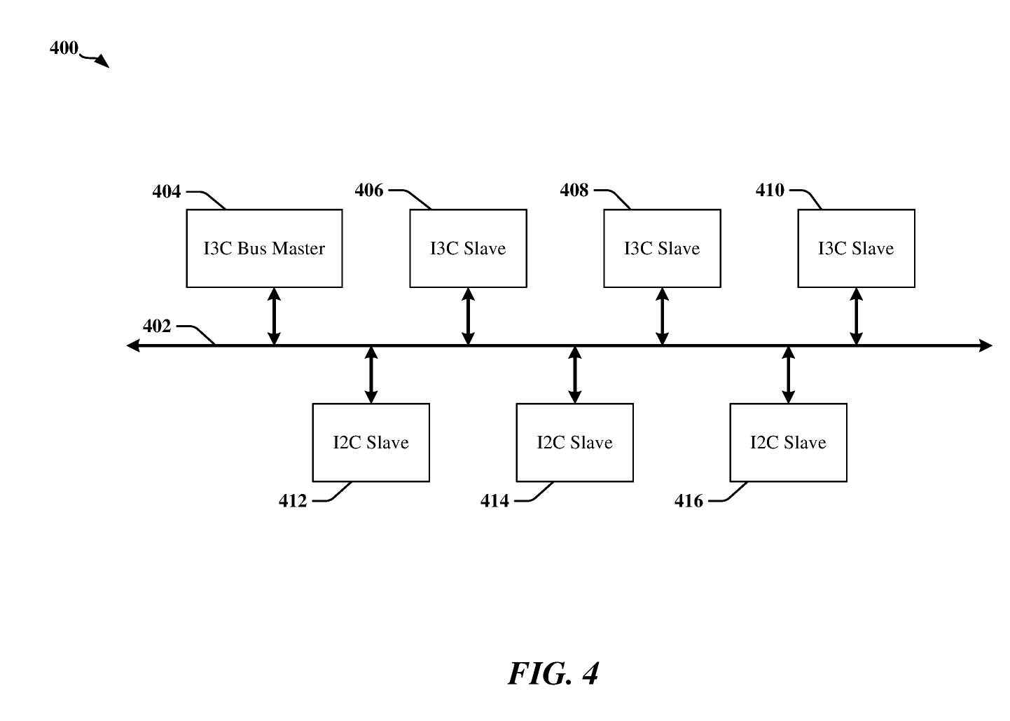

FIG. 4 illustrates a communication link 400 in which a I3C devices 404, 406, 408 and 410 coexist with I2C devices 412, 414 and 416 on a serial bus 402. That is, the I3C devices 404, 406, 408 and 410, 412, 414 and 416 may be adapted or configured to communicate over the serial bus 402 in accordance with an I3C protocol, while the I2C devices 412, 414 and 416 may be adapted or configured to communicate over the serial bus 402 in accordance with an I2C protocol and may include one or more legacy devices that employ clock stretching. In some instances, one or more of the I3C devices 404, 406, 408 and 410 may communicate using other protocols, including an I2C protocol, for example.

Communication over the serial bus 402 may be controlled by an I3C master device 404 that can also function as an I2C master. In one mode of operation, the master device 404 may be configured to provide a clock signal that controls timing of a data signal. In another mode of operation, two or more of the devices 404, 406, 408, 410, 412, 414 and 416 may be configured to exchange data encoded in symbols, where timing information is embedded in the transmission of the symbols.

Timing in an I2C Bus

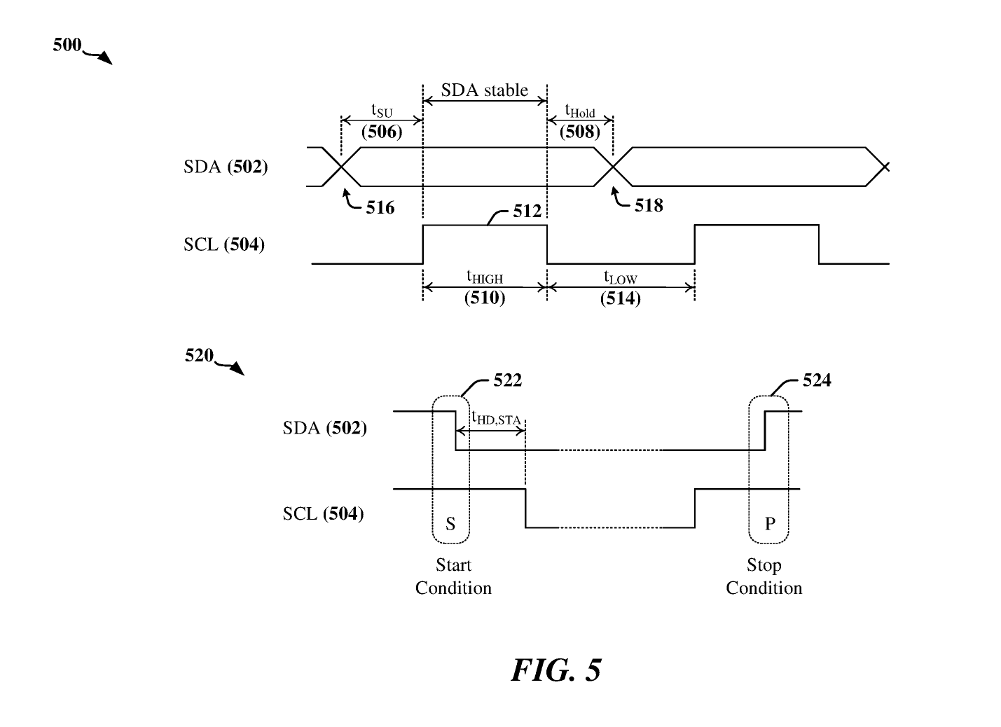

FIG. 5 includes timing diagrams 500 and 520 that illustrate the relationship between the SDA wire 502 and the SCL wire 504 on a conventional I2C bus. The first timing diagram 500 illustrates the timing relationship between the SDA wire 502 and the SCL wire 504 while data is being transferred on the conventionally configured I2C bus. The SCL wire 504 provides a series of pulses that can be used to sample data in the SDA wire 502. The pulses (including the pulse 512, for example) may be defined as the time during which the SCL wire 504 is determined to be in a high logic state at a receiver. When the SCL wire 504 is in the high logic state during data transmission, data on the SDA wire 502 is required to be stable and valid; the state of the SDA wire 502 is not permitted to change when the SCL wire 504 is in the high logic state.

Specifications for conventional I2C protocol implementations (which may be referred to as “I2C Specifications”) define a minimum duration 510 (t_{HIGH}) of the high period of the pulse 512 on the SCL wire 504. The I2C Specifications also define minimum durations for a setup time 506 (t_{SU}) before occurrence of the pulse 512, and a hold time 508 (t_{Hold}) after the pulse 512 terminates. The signaling state of the SDA wire 502 is expected to be stable during the setup time 506 and the hold time 508. The setup time 506 defines a maximum time period after a transition 516 between signaling states on the SDA wire 502 until the arrival of the rising edge of the pulse 512 on the SCL wire 504. The hold time 508 defines a minimum time period after the falling edge of the pulse 512 on the SCL wire 504 until a next transition 518 between signaling states on the SDA wire 502. The I2C Specifications also define a minimum duration 514 for a low period (t_{LOW}) for the SCL wire 504. The data on the SDA wire 502 is typically stable and/or can be captured for the duration 510 (t_{HIGH}) when the SCL wire 504 is in the high logic state after the leading edge of the pulse 512.

The second timing diagram 520 of FIG. 5 illustrates signaling states on the SDA wire 502 and the SCL wire 504 between data transmissions on a conventional I2C bus. The I2C protocol provides for transmission of 8-bit data (bytes) and 7-bit addresses. A receiver may acknowledge transmissions by driving the SDA wire 502 to the low logic state for one clock period. The low signaling state represents an acknowledgement (ACK) indicating successful reception and a high signaling state represents a negative acknowledgement (NACK) indicating a failure to receive or an error in reception.

A START condition 522 is defined to permit the current bus master to signal that data is to be transmitted. The START condition 522 occurs when the SDA wire 502 transitions from high to low while the SCL wire 504 is high. The I2C bus master initially transmits the START condition 522, which may be also be referred to as a start bit, followed by a 7-bit address of an I2C slave device with which it wishes to exchange data. The address is followed by a single bit that indicates whether a read or write operation is to occur. The addressed I2C slave device, if available, responds with an ACK bit. If no I2C slave device responds, the I2C bus master may interpret the high logic state of the SDA wire 502 as a NACK. The master and slave devices may then exchange bytes of information in frames, in which the bytes are serialized such that the most significant bit (MSB) is transmitted first. The transmission of the byte is completed when a STOP condition 524 is transmitted by the I2C master device. The STOP condition 524 occurs when the SDA wire 502 transitions from low to high while the SCL wire 504 is high. The I2C Specifications require that all transitions of the SDA wire 502 occur when the SCL wire 504 is low, and exceptions may be treated as a START condition 522 or a STOP condition 524.

High-Speed Data Transfers Over an I3C Serial Bus

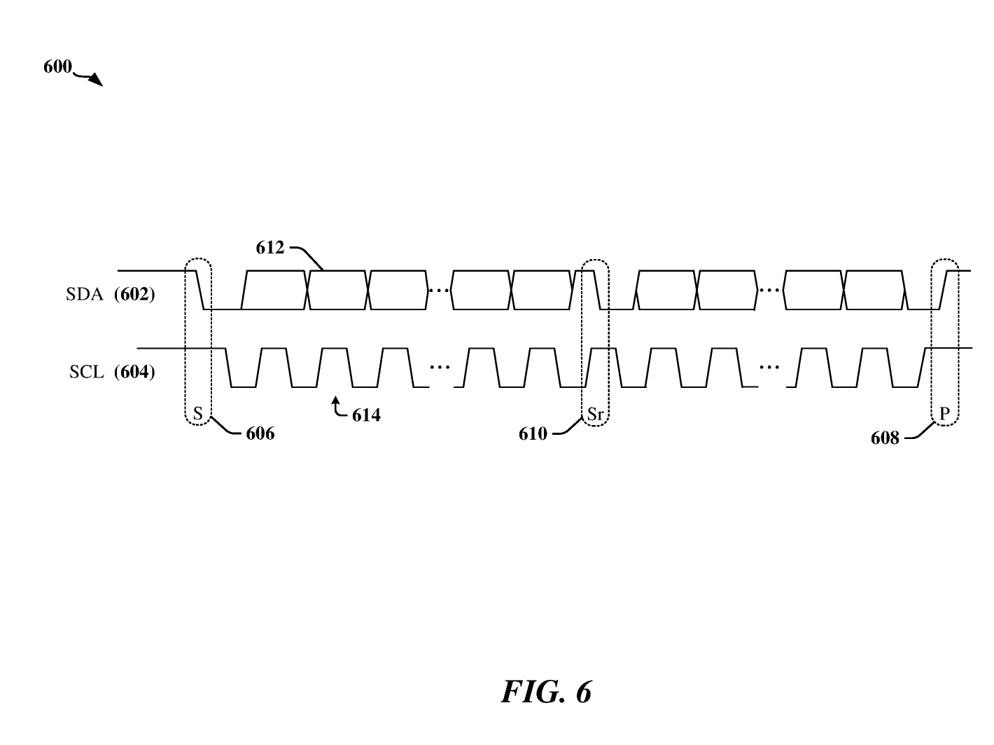

FIG. 6 includes a timing diagram 600 that illustrates signaling on a serial bus when the serial bus is operated in a single data rate (SDR) mode of operation defined by I3C specifications. Data transmitted on a first wire (the SDA wire 602) of the serial bus may be captured using a clock signal transmitted on a second wire (the SCL wire 604) of the serial bus. During data transmission, the signaling state 612 of the SDA wire 602 is expected to remain constant for the duration of the pulses 614 when the SCL wire 604 is at a high voltage level. Transitions on the SDA wire 602 when the SCL wire 604 is at the high voltage level indicate a START condition 606, a STOP condition 608 or a repeated START 610.

On an I3C serial bus, a START condition 606 is defined to permit the current bus master to signal that data is to be transmitted. The START condition 606 occurs when the SDA wire 602 transitions from high to low while the SCL wire 604 is high. The bus master may signal completion and/or termination of a transmission using a STOP condition 608. The STOP condition 608 is indicated when the SDA wire 602 transitions from low to high while the SCL wire 604 is high. A repeated START 610 may be transmitted by a bus master that wishes to initiate a second transmission upon completion of a first transmission. The repeated START 610 is transmitted instead of, and has the significance of a STOP condition 608 followed immediately by a START condition 606. The repeated START 610 occurs when the SDA wire 602 transitions from high to low while the SCL wire 604 is high.

I2C Clock Stretch

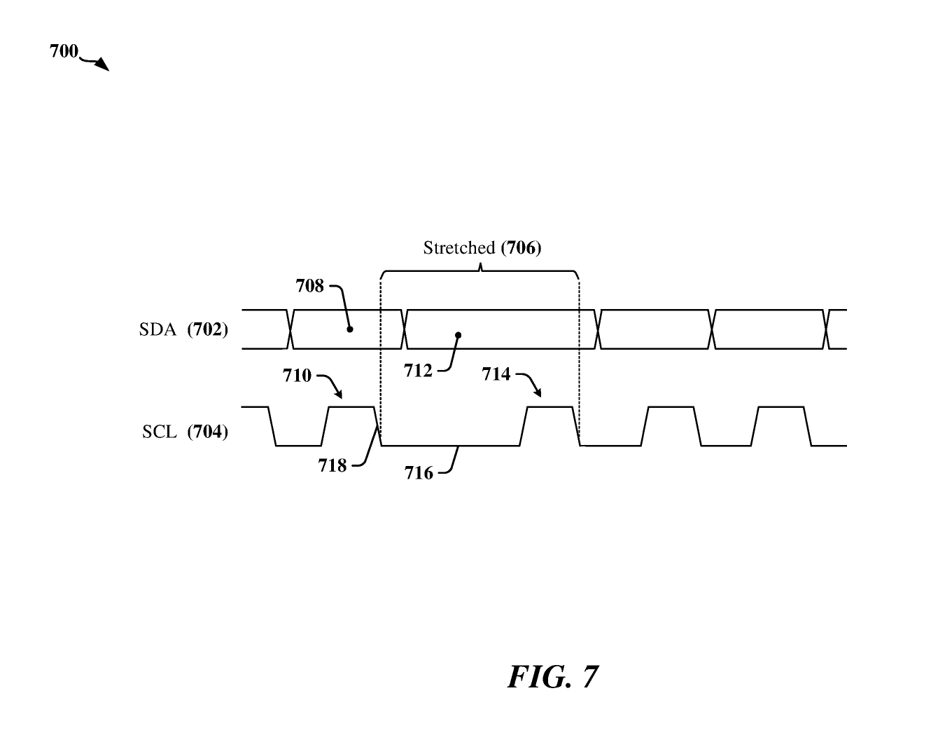

FIG. 7 is a timing diagram 700 illustrating the effect of clock stretch in an I2C bus. A master device may be transmitting data over the SDA wire 702 in accordance with the timing provided by the clock signal transmitted on the SCL wire 704. The clock signal may include a stretched period 706, when the duration of a low voltage state 716 on the SCL wire 704 is extended by a slave device. A first bit of data 708 is stable for the duration of a first pulse 710 of the clock signal transmitted on the SCL wire 704. The first bit of data 708 may be sampled by the slave based on the timing of the pulse 710. After the falling edge 718 of the clock, the master device may transmit a second bit of data 712. The slave device may delay sampling the second bit of data 712 by driving the SCL wire 704 in order to delay the transmission of a second pulse 714 that may be used to sample the second bit of data 712.

Conventional I3C master devices are not equipped with open-drain drivers that permit the I3C master devices to support I2C clock stretch. An I3C master device adapted in accordance with certain aspects disclosed herein can support I2C clock stretch and support a broader variety of legacy I2C devices than conventional I3C master devices can support.

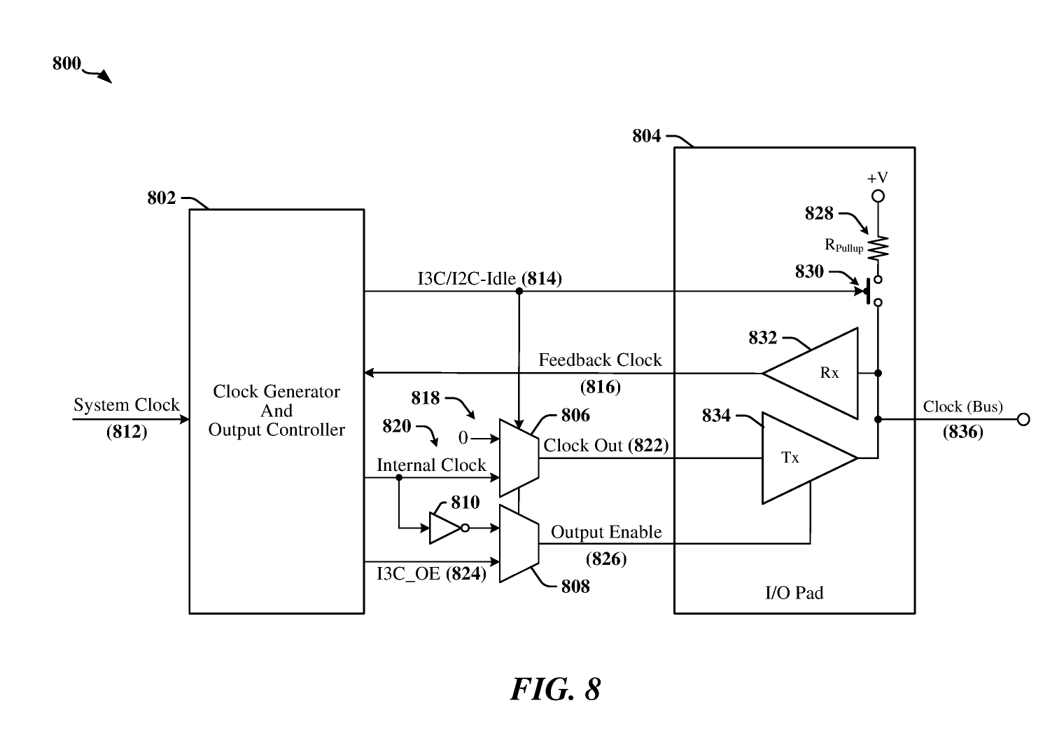

FIG. 8 illustrates certain aspects of an I3C master device 800 that has been adapted according to certain aspects disclosed herein. A signal transmitted through an input/output pad 804 to the clock wire 836 of a serial bus may be derived from an internal clock signal 820 provided by a clock generator and output controller 802. In one example, the clock generator and output controller 802 may correspond to or include components such as the clock generation circuit 308, the control logic 312, and/or driver control circuits and modules 326 illustrated in FIG. 3. The clock generator and output controller 802 may generate the internal clock signal 820 using a system clock 812 available on the IC that includes the I3C master device 800. A first multiplexer 806 provides an output clock signal 822 to a line driver 834. The first multiplexer 806 selects between the internal clock signal 820 and a constant low voltage level input 818. The line driver 834 may have a tristate, push-pull output stage. A mode signal 814 is used to control the first multiplexer 806 such that the output clock signal 822 follows the internal clock signal 820 in an I3C mode of operation, and is low (following the low voltage level input 818) when the serial bus is operated in I2C mode, or is idle.

A second multiplexer 808 provides an output enable signal 826 to control the output stage of the line driver 834. The output enable signal 826 follows an I3C output enable signal 824 when the mode signal 814 indicates an I3C mode of operation. When the mode signal 814 indicates an I2C mode of operation, the output enable signal 826 being representative of the internal clock signal 820 (e.g., the inverse of the internal clock signal 820 provided by the inverter 810). In I2C mode, the output stage of the line driver 834 is in a high-impedance state when the internal clock signal 820 is in the high state. The output of the line driver 834 is coupled through a switch 830 to a pull-up resistor 828. The switch 830 is closed when the mode signal 814 selects I2C mode or idle mode. In the I2C mode, the output of the line driver 834 is pulled to the high state by the pull-up resistor 828, unless a slave device drives the clock wire 836 low. A receiver 832 monitors the clock wire 836 and provides a feedback signal 816 to the clock generator and output controller 802. The feedback signal 816 enables the clock generator and output controller 802 to recognize that a slave device is stretching the signal on the clock wire 836. The clock generator may then adjust timing of the internal clock signal 820 to enable exit from the clock stretch period in a manner that meets I2C protocols.

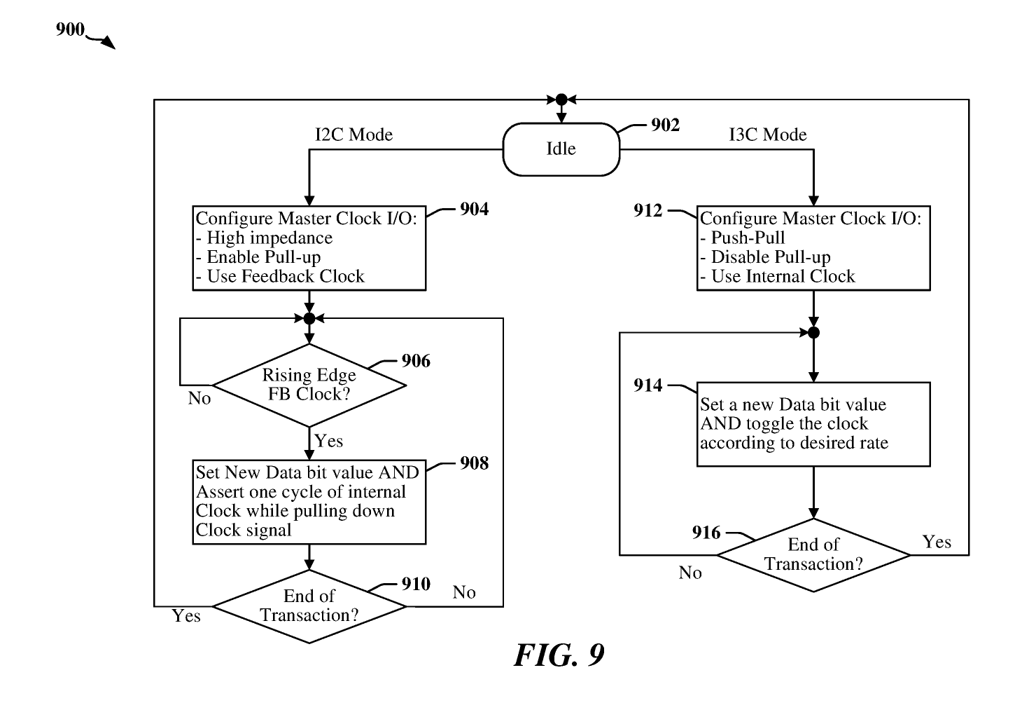

FIG. 9 is a flowchart 900 that illustrates a process for operating clock generation and transmission circuits in an interface of an I3C master device that has been adapted in accordance with certain aspects disclosed herein. The process may be implemented using sequencing logic or a state machine, for example. The interface may initially be in an idle state 902. In the idle state 902, the output of the line driver 834 may be in the high impedance state, the switch 830 is closed, and the clock wire 836 is pulled to the high state by the pull-up resistor 828.

The interface may transition from the idle state 902 when the bus master has initiated an I2C transaction. The process for managing the line driver 834 in I2C mode may commence at block 904, where the interface may configure the clock input/output (I/O) circuit by causing the line driver 834 to be in the high impedance state, the switch 830 to be closed. The clock generator and output controller 802 may provide the feedback signal 816 as the internal clock signal 820.

At block 906 the interface may wait for a rising edge on the feedback signal 816 that indicates that the slave device has released the clock wire 836, or that clock wire 836 is not being driven by a slave device upon exit from the idle state 902. If no rising edge is detected at block 906 (the clock wire 836 is in the low state), the interface continues to wait. If a rising edge is detected at block 906 (the clock wire 836 is not driven by a slave device), the process continues at block 908. At block 908, the interface may set a new data bit on the data wire of the serial interface and wait one cycle of the internal clock signal 820 while pulling the clock wire 836 low. After the cycle of the internal clock signal 820 has elapsed, the clock wire 836 is driven high to provide a pulse on the clock wire 836.

At block 910, the interface may determine if the transaction has been completed. If the transaction has been completed, then the interface may reenter the idle state 902. If the transaction has not been completed, then the process continues at block 906.

The process for managing the line driver 834 in I3C mode may commence at block 912, where the interface may configure the clock I/O circuit by causing the line driver 834 to operate in normal push-pull mode. That is, high impedance mode is not used in I3C mode. The switch 830 is closed. The clock generator and output controller 802 uses the internal clock signal 820 generated from the system clock 812.

At block 914 the interface may set a new data bit on the data wire of the serial interface and toggle the internal clock signal 820 according to a desired data transmission rate and/or in accordance with the I3C protocol.

At block 916, the interface may determine if the transaction has been completed. If the transaction has been completed, then the interface may reenter the idle state 902. If the transaction has not been completed, then the process continues at block 914.

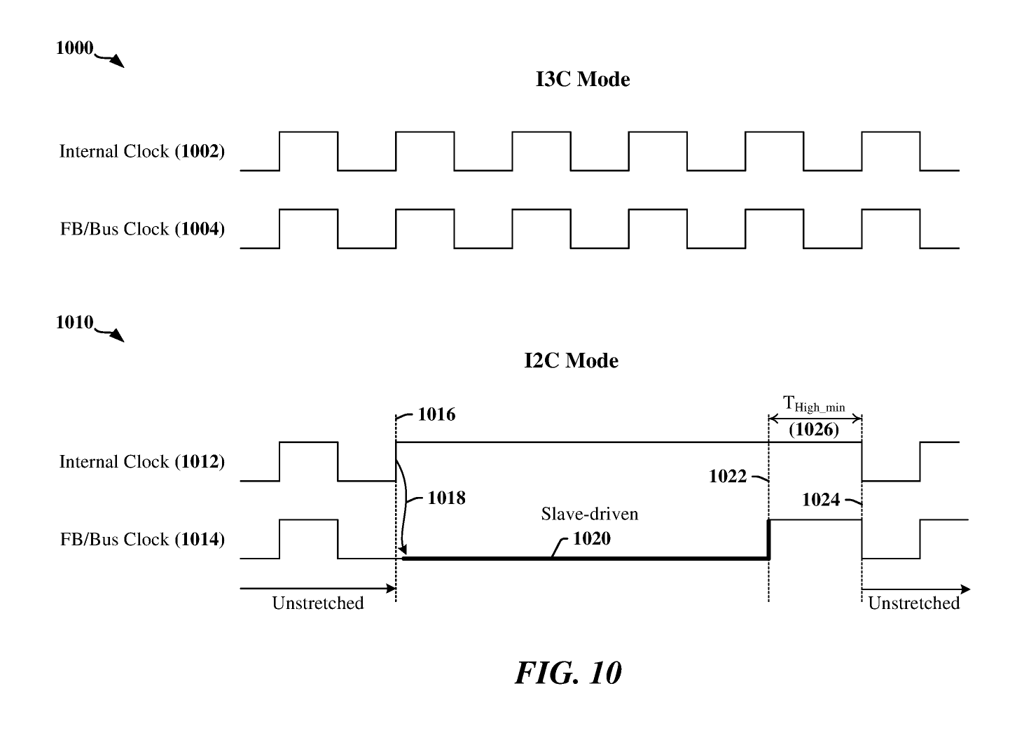

FIG. 10 includes timing diagrams 1000, 1010 that illustrate clock timing when a serial bus is operated in I3C and I2C modes. The first timing diagram 1000 illustrates an I3C mode of operation, where the feedback and/or bus clock signal 1004 follows the internal clock signal 1002.

The second timing diagram 1010 illustrates an I2C mode of operation, and includes an example of clock stretch. The feedback and/or bus clock signal 1014 initially follows the internal clock signal 1012 until a slave device drives the clock wire 836 low. The master device may attempt to assert a high level on the clock wire 836 at a time 1016 when the master device ceases driving the clock wire 836 low. The pull-up resistor 828 tends to pull the clock wire 836 high, except that a slave may have asserted a low voltage overriding 1018 the pull-up resistor 828. The clock wire 836 may remain at a low voltage state for a period of time 1020 determined by the slave device. When this period of time 1020 has elapsed, the clock wire 836 is pulled high by the pull-up resistor 828 at a time 1022. The interface may maintain the high state for a minimum period of time 1026 that may be defined by I2C protocols, for example. After expiration of the minimum period of time 1026 (at time 1024), the interface may drive the clock wire 836 low and the feedback and/or bus clock signal 1014 follows the internal clock signal 1012.

Examples of Processing Circuits and Methods

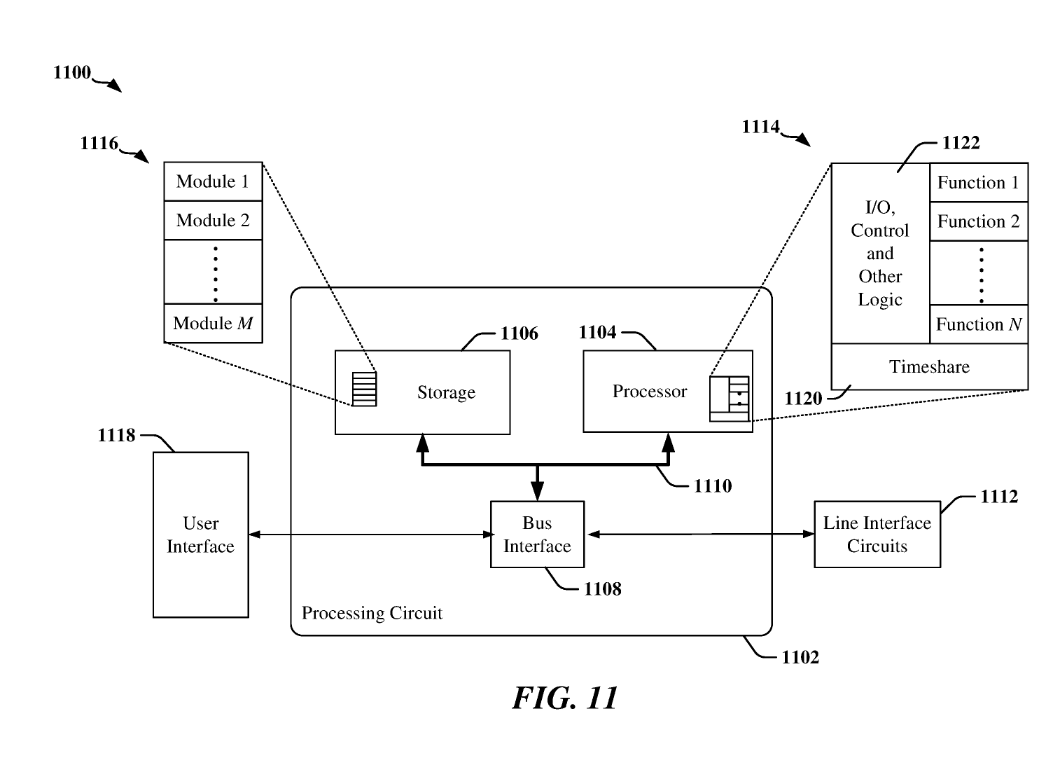

FIG. 11 is a diagram illustrating an example of a hardware implementation for an apparatus 1100 employing a processing circuit 1102 that may be configured to perform one or more functions disclosed herein. In accordance with various aspects of the disclosure, an element, or any portion of an element, or any combination of elements as disclosed herein may be implemented using the processing circuit 1102. The processing circuit 1102 may include one or more processors 1104 that are controlled by some combination of hardware and software modules. Examples of processors 1104 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1104 may include specialized processors that perform specific functions, and that may be configured, augmented or controlled by one of the software modules 1116. The one or more processors 1104 may be configured through a combination of software modules 1116 loaded during initialization, and further configured by loading or unloading one or more software modules 1116 during operation. In various examples, the processing circuit 1102 may be implemented using a state machine, sequencer, signal processor and/or general-purpose processor, or a combination of such devices and circuits.

In the illustrated example, the processing circuit 1102 may be implemented with a bus architecture, represented generally by the bus 1110. The bus 1110 may include any number of interconnecting buses and bridges depending on the specific application of the processing circuit 1102 and the overall design constraints. The bus 1110 links together various circuits including the one or more processors 1104, and storage 1106. Storage 1106 may include memory devices and mass storage devices, and may be referred to herein as computer-readable media and/or processor-readable media. The bus 1110 may also link various other circuits such as timing sources, timers, peripherals, voltage regulators, and power management circuits. A bus interface 1108 may provide an interface between the bus 1110 and one or more transceivers 1112. A transceiver 1112 may be provided for each networking technology supported by the processing circuit. In some instances, multiple networking technologies may share some or all of the circuitry or processing modules found in a transceiver 1112. Each transceiver 1112 provides a means for communicating with various other apparatus over a transmission medium. Depending upon the nature of the apparatus 1100, a user interface 1118 (e.g., keypad, display, speaker, microphone, joystick) may also be provided, and may be communicatively coupled to the bus 1110 directly or through the bus interface 1108.

A processor 1104 may be responsible for managing the bus 1110 and for general processing that may include the execution of software stored in a computer-readable medium that may include the storage 1106. In this respect, the processing circuit 1102, including the processor 1104, may be used to implement any of the methods, functions and techniques disclosed herein. The storage 1106 may be used for storing data that is manipulated by the processor 1104 when executing software, and the software may be configured to implement any one of the methods disclosed herein.

One or more processors 1104 in the processing circuit 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1106 or in an external computer-readable medium. The external computer-readable medium and/or storage 1106 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1106 may also include, by way of example, a carrier wave, a transmission line, and any other suitable medium for transmitting software and/or instructions that may be accessed and read by a computer. Computer-readable medium and/or the storage 1106 may reside in the processing circuit 1102, in the processor 1104, external to the processing circuit 1102, or be distributed across multiple entities including the processing circuit 1102. The computer-readable medium and/or storage 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1106 may maintain software maintained and/or organized in loadable code segments, modules, applications, programs, etc., which may be referred to herein as software modules 1116. Each of the software modules 1116 may include instructions and data that, when installed or loaded on the processing circuit 1102 and executed by the one or more processors 1104, contribute to a run-time image 1114 that controls the operation of the one or more processors 1104. When executed, certain instructions may cause the processing circuit 1102 to perform functions in accordance with certain methods, algorithms and processes described herein.

Some of the software modules 1116 may be loaded during initialization of the processing circuit 1102, and these software modules 1116 may configure the processing circuit 1102 to enable performance of the various functions disclosed herein. For example, some software modules 1116 may configure internal devices and/or logic circuits 1122 of the processor 1104, and may manage access to external devices such as the transceiver 1112, the bus interface 1108, the user interface 1118, timers, mathematical coprocessors, and so on. The software modules 1116 may include a control program and/or an operating system that interacts with interrupt handlers and device drivers, and that controls access to various resources provided by the processing circuit 1102. The resources may include memory, processing time, access to the transceiver 1112, the user interface 1118, and so on.

One or more processors 1104 of the processing circuit 1102 may be multifunctional, whereby some of the software modules 1116 are loaded and configured to perform different functions or different instances of the same function. The one or more processors 1104 may additionally be adapted to manage background tasks initiated in response to inputs from the user interface 1118, the transceiver 1112, and device drivers, for example. To support the performance of multiple functions, the one or more processors 1104 may be configured to provide a multitasking environment, whereby each of a plurality of functions is implemented as a set of tasks serviced by the one or more processors 1104 as needed or desired. In one example, the multitasking environment may be implemented using a timesharing program 1120 that passes control of a processor 1104 between different tasks, whereby each task returns control of the one or more processors 1104 to the timesharing program 1120 upon completion of any outstanding operations and/or in response to an input such as an interrupt. When a task has control of the one or more processors 1104, the processing circuit is effectively specialized for the purposes addressed by the function associated with the controlling task. The timesharing program 1120 may include an operating system, a main loop that transfers control on a round-robin basis, a function that allocates control of the one or more processors 1104 in accordance with a prioritization of the functions, and/or an interrupt driven main loop that responds to external events by providing control of the one or more processors 1104 to a handling function.

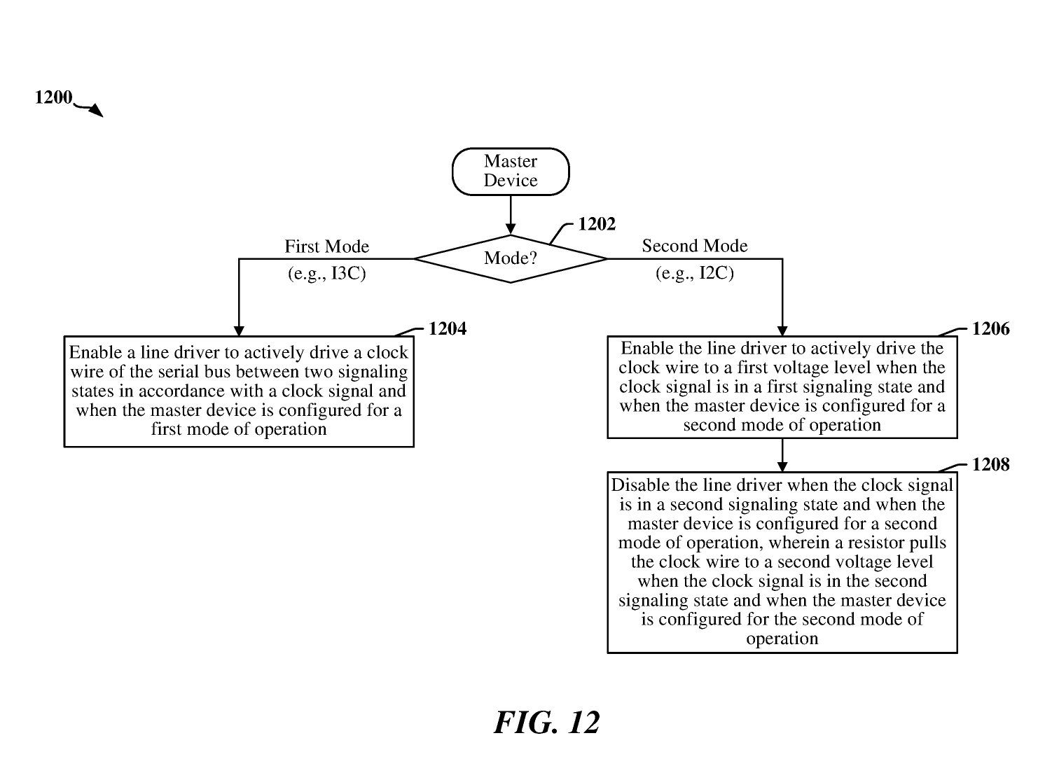

FIG. 12 is a flowchart 1200 illustrating a method performed at a master device coupled to a serial bus that is configured to support I2C clock stretch when the serial bus supports both I3C and I2C slave devices. At block 1202, the master device may determine a mode of operation for the serial bus. The mode of operation may be determined from configuration parameters, signaling transmitted on the serial bus, and/or capabilities of a device to be engaged in a transaction with the master device. Where two or more modes of operation are supported by the master device, the master device may determine at block 1202 that a first mode operation is to be configured, and the master device may continue the method at block 1204. In one example, the first mode of operation may correspond to an I3C mode of operation. The master device may determine at block 1202 that a second mode operation is to be configured, and the master device may continue the method at block 1206. In some examples, the second mode of operation may correspond to an I2C mode of operation.

At block 1204, the master device may enable a line driver 834 to actively drive a clock wire 836 of the serial bus between two signaling states in accordance with a clock signal 820, when the master device is configured for a first mode of operation. The line driver may be a tristate push-pull driver.

At block 1206, the master device may enable the line driver 834 to actively drive the clock wire 836 to a first voltage level when the clock signal 820 is in a first signaling state and when the master device is configured for a second mode of operation.

At block 1208, the master device may disable the line driver 834 when the clock signal 820 is in a second signaling state and when the master device is configured for a second mode of operation. A resistor 828 may pull the clock wire 836 to a second voltage level when the clock signal 820 is in the second signaling state and when the master device is configured for the second mode of operation.

In some examples, the master device may provide a feedback signal 816 representative of the signaling state of the clock wire 836, and may modify the clock signal 820 when the feedback signal indicates that the clock wire 836 is in the first signaling state while the line driver 834 is disabled. Modifying the clock signal 820 may include suppressing the clock signal 820 while the feedback signal 816 indicates that the clock wire 836 is in the first signaling state and while the line driver 834 is disabled, refraining from driving the clock wire 836 for a period of time associated with a pulse width defined by a protocol controlling communication on the serial bus after the feedback signal 816 indicates that the clock wire 836 has transitioned to the second signaling state, and enabling the line driver 834 to actively drive the clock wire 836 to the first voltage level when the clock signal 820 is in the first signaling state and when the period of time has expired. The feedback signal 816 may be provided by a line receiver 832 coupled to the clock wire 836.

In one example, the master device may use an enable signal 826 derived from the clock signal 820 to control enablement of the line driver when the master device is configured for a second mode of operation.

In one example, the master device may close a switch 830 that couples the clock wire 836 to a voltage source through the resistor 828 when the master device is configured for the second mode of operation.

In one example, the serial bus is operated in accordance with an I3C protocol in the first mode of operation. The serial bus may be operated in accordance with an I2C protocol in the second mode of operation.

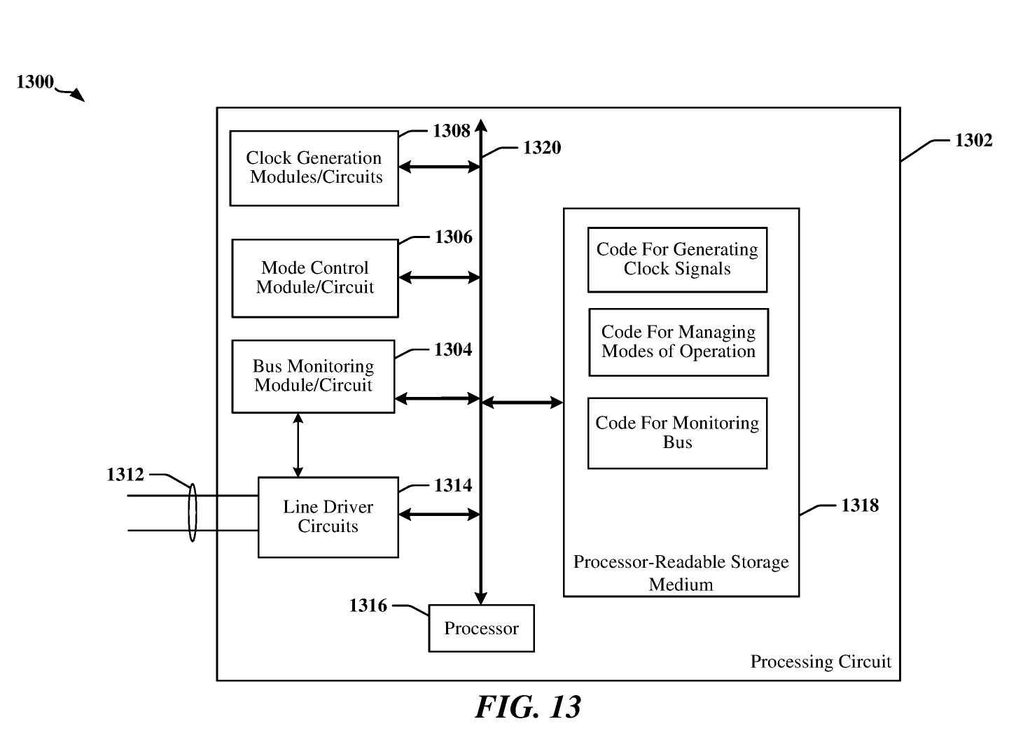

FIG. 13 is a diagram illustrating a simplified example of a hardware implementation for an apparatus 1300 employing a processing circuit 1302. The processing circuit may have a controller or processor 1316 that may include one or more microprocessors, microcontrollers, digital signal processors, sequencers and/or state machines. The processing circuit 1302 may be implemented with a bus architecture, represented generally by the bus 1320. The bus 1320 may include any number of interconnecting buses and bridges depending on the specific application of the processing circuit 1302 and the overall design constraints. The bus 1320 links together various circuits including one or more processors and/or hardware modules, represented by the controller or processor 1316, the modules or circuits 1304, 1306 and 1308, and the computer-readable storage medium 1318. The apparatus may be coupled to a multi-wire communication link using a physical layer circuit 1314. The physical layer circuit 1314 may operate the multi-wire communication link 1312 to support communications in accordance with I3C protocols. The bus 1320 may also link various other circuits such as timing sources, peripherals, voltage regulators, and power management circuits, which are well known in the art, and therefore, will not be described any further.

The processor 1316 is responsible for general processing, including the execution of software, code and/or instructions stored on the computer-readable storage medium 1318. The computer-readable storage medium may include a non-transitory storage medium. The software, when executed by the processor 1316, causes the processing circuit 1302 to perform the various functions described supra for any particular apparatus. The computer-readable storage medium may be used for storing data that is manipulated by the processor 1316 when executing software. The processing circuit 1302 further includes at least one of the modules 1304, 1306 and 1308. The modules 1304, 1306 and 1308 may be software modules running in the processor 1316, resident/stored in the computer-readable storage medium 1318, one or more hardware modules coupled to the processor 1316, or some combination thereof. The modules 1304, 1306 and 1308 may include microcontroller instructions, state machine configuration parameters, or some combination thereof.

In one configuration, the apparatus 1300 is embodied in a master device that is adapted to support I2C and I3C communication protocols. The apparatus 1300 includes modules and/or circuits 1308 configured to generate one or more clock signals that may be used to control transmissions on a multi-wire communication link 1312, which may be operated as a serial bus. The apparatus 1300 includes a module and/or circuit 1306 adapted to configure the apparatus in order to support different protocols and to enable legacy I2C slave devices to employ clock stretching. The apparatus 1300 includes modules and/or circuits 1304 that monitor the multi-wire communication link 1312, and that may detect clock stretching by the legacy I2C slave devices.

In some examples, the apparatus 1300 includes a line driver coupled to a first wire of a multi-wire serial bus, a clock generator circuit configured to provide a clock signal configured to control data transmissions on the multi-wire serial bus, a first multiplexer responsive to a mode select signal and configured to provide an output enable signal to the line driver, and a second multiplexer responsive to the mode select signal and configured to provide the clock signal to the line driver in a first mode. In the first mode, the line driver may be enabled and actively drives the first wire of the serial bus between two signaling states in accordance with the clock signal, and in a second mode, the line driver is switched between an active mode and a high-impedance mode based on signaling state of the clock signal. The apparatus 1300 may include a switch responsive to the mode select signal. The switch may couple the first wire of the serial bus to a pull-up voltage resistor in the second mode. The second multiplexer may provide a low voltage level to the line driver in the second mode.

In various examples, the apparatus 1300 includes a receiver coupled to the first wire of the serial bus and configured to providing a feedback signal representative of the signaling state of the first wire of the serial bus. The clock generator circuit may be configured to modify the clock signal when the feedback signal indicates that the first wire of the serial bus is in a first signaling state corresponding to the low voltage level while the line driver is disabled. The clock generator circuit may be configured to modify the clock signal by suppressing the clock signal while the feedback signal indicates that the first wire of the serial bus is in the first signaling state while the line driver is disabled, refraining from driving the first wire of the serial bus for a period of time associated with a pulse width defined by a protocol controlling communication on the serial bus after the feedback signal indicates that the first wire of the serial bus has transitioned from the first signaling state, and enabling the line driver to actively drive the first wire of the serial bus to the low voltage level when the clock signal is in the first signaling state and when the period of time has expired.

In one example, the line driver is a push-pull driver.

In one example, the serial bus is operated in accordance with an I3C protocol in the first mode, and the serial bus is operated in accordance with an I2C protocol in the second mode.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a master device coupled to a serial bus, comprising:
enabling a line driver to actively drive a clock wire of the serial bus between two signaling states in accordance with a clock signal and when the master device is configured for a first mode of operation;
enabling the line driver to actively drive the clock wire to a first voltage level when the clock signal is in a first signaling state and when the master device is configured for a second mode of operation; and
disabling the line driver when the clock signal is in a second signaling state and when the master device is configured for a second mode of operation,
wherein a resistor pulls the clock wire to a second voltage level when the clock signal is in the second signaling state and when the master device is configured for the second mode of operation.

2. The method of claim 1, further comprising:
providing a feedback signal representative of the signaling state of the clock wire; and
modifying the clock signal when the feedback signal indicates that the clock wire is in the first signaling state while the line driver is disabled.

3. The method of claim 2, wherein modifying the clock signal comprises:
suppressing the clock signal while the feedback signal indicates that the clock wire is in the first signaling state and while the line driver is disabled;
refraining from driving the clock wire for a period of time associated with a pulse width defined by a protocol controlling communication on the serial bus after the feedback signal indicates that the clock signal has transitioned to the second signaling state; and
enabling the line driver to actively drive the clock wire to the first voltage level when the clock signal is in the first signaling state and when the period of time has expired.

4. The method of claim 2, wherein the feedback signal is provided by a line receiver coupled to the clock wire.

5. The method of claim 1, further comprising:
using an enable signal derived from the clock signal to control enablement of the line driver when the master device is configured for a second mode of operation.

6. The method of claim 1, further comprising:
when the master device is configured for the second mode of operation, closing a switch that couples the clock wire to a voltage source through the resistor.

7. The method of claim 1, wherein the line driver comprises a push-pull driver.

8. The method of claim 1, wherein the serial bus is operated in accordance with an I3C protocol in the first mode of operation.

9. The method of claim 8, wherein the serial bus is operated in accordance with an I2C protocol in the second mode of operation.

10. An apparatus, comprising:
a line driver coupled to a first wire of a multi-wire serial bus;
a clock generator circuit configured to provide a clock signal configured to control data transmissions on the multi-wire serial bus;
a first multiplexer responsive to a mode select signal and configured to provide an output enable signal to the line driver, wherein:
in a first mode, the line driver is enabled and actively drives the first wire of the serial bus between two signaling states in accordance with the clock signal; and
in a second mode, the line driver is switched between an active mode and a high-impedance mode based on signaling state of the clock signal;
a switch responsive to the mode select signal, wherein the switch couples the first wire of the serial bus to a pull-up voltage resistor in the second mode; and
a second multiplexer responsive to the mode select signal and configured to provide the clock signal to the line driver in the first mode, and to provide a low voltage level to the line driver in the second mode.

11. The apparatus of claim 10, further comprising:
a receiver coupled to the first wire of the serial bus and configured to providing a feedback signal representative of the signaling state of the first wire of the serial bus, wherein the clock generator circuit is configured to modify the clock signal when the feedback signal indicates that the first wire of the serial bus is in a first signaling state corresponding to the low voltage level while the line driver is disabled.

12. The apparatus of claim 11, wherein the clock generator circuit is configured to modify the clock signal by:
suppressing the clock signal while the feedback signal indicates that the first wire of the serial bus is in the first signaling state while the line driver is disabled;
refraining from driving the first wire of the serial bus for a period of time associated with a pulse width defined by a protocol controlling communication on the serial bus after the feedback signal indicates that the first wire of the serial bus has transitioned from the first signaling state; and
enabling the line driver to actively drive the first wire of the serial bus to the low voltage level when the clock signal is in the first signaling state and when the period of time has expired.

13. The apparatus of claim 10, wherein the line driver comprises a push-pull driver.

14. The apparatus of claim 10, wherein the serial bus is operated in accordance with an I3C protocol in the first mode.

15. The apparatus of claim 10, wherein the serial bus is operated in accordance with an I2C protocol in the second mode.

16. An apparatus, comprising:
means for providing a clock signal configured to control timing of data transmissions on a serial bus;
means for controlling drive state of a line driver coupled to a clock wire of the serial bus, wherein the means for controlling the drive state of the line driver is configured to:
enable an output of the line driver when the clock signal is in a first signaling state and when the clock signal is in a second signaling state while the apparatus is configured for a first mode of operation;
enable an output of the line driver when the clock signal is in the first signaling state and when the apparatus is configured for a second mode of operation; and
disable the output of the line driver when the clock signal is in the second signaling state and when the apparatus is configured for the second mode of operation,
wherein the line driver is configured to actively drive the clock wire to a first voltage level when the output of the line driver is enabled and the clock signal is in the first signaling state; and
means for pulling the clock wire to a second voltage level when the output of the line driver is disabled.

17. The apparatus of claim 16, further comprising:
means for providing a feedback signal representative of the signaling state of the clock wire,
wherein the means for providing a clock signal is configured to modify the clock signal when the feedback signal indicates that the clock wire is in the first signaling state and when the line driver is disabled.

18. The apparatus of claim 17, wherein the means for providing a clock signal is configured to modify the clock signal by:
suppressing the clock signal while the feedback signal indicates that the clock wire is in the first signaling state and while the line driver is disabled;
refraining from driving the clock wire for a period of time associated with a pulse width defined by a protocol controlling communication on the serial bus after the feedback signal indicates that the clock signal has transitioned to the second signaling state; and
enabling the line driver to actively drive the clock wire to the first voltage level when the clock signal is in the first signaling state and when the period of time has expired.

19. The apparatus of claim 17, wherein the feedback signal is provided by a line receiver coupled to the clock wire.

20. The apparatus of claim 16, wherein the means for controlling the drive state of the line driver is configured to:
use an enable signal derived from the clock signal to control enablement of the line driver when the apparatus is configured for a second mode of operation.

21. The apparatus of claim 16, wherein the means for pulling the clock wire to the second voltage level comprises:
a resistor; and
a switch that couples the clock wire to a voltage source through the resistor when the apparatus is configured for the second mode of operation.

22. The apparatus of claim 16, wherein the line driver comprises a push-pull driver.

23. The apparatus of claim 16, wherein the serial bus is operated in accordance with an I3C protocol in the first mode of operation.

24. The apparatus of claim 23, wherein the serial bus is operated in accordance with an I2C protocol in the second mode of operation.

25. A processor readable storage medium having code stored thereon that is executable by a processor of a master device, the code comprising instructions for:
enabling a line driver to actively drive a clock wire of a serial bus between two signaling states in accordance with a clock signal and when the master device is configured for a first mode of operation;
enabling the line driver to actively drive the clock wire to a first voltage level when the clock signal is in a first signaling state and when the master device is configured for a second mode of operation; and
disabling the line driver when the clock signal is in a second signaling state and when the master device is configured for a second mode of operation,
wherein a resistor pulls the clock wire to a second voltage level when the clock signal is in the second signaling state and when the master device is configured for the second mode of operation.

26. The storage medium of claim 25, wherein the code comprises instructions for:
causing a feedback signal representative of the signaling state of the clock wire to be provided; and
causing the clock signal to be modified when the feedback signal indicates that the clock wire is in the first signaling state while the line driver is disabled.

27. The storage medium of claim 26, wherein the code comprises instructions for:
causing the clock signal to be suppressed while the feedback signal indicates that the clock wire is in the first signaling state and while the line driver is disabled;
refraining from driving the clock wire for a period of time associated with a pulse width defined by a protocol controlling communication on the serial bus after the feedback signal indicates that the clock signal has transitioned to the second signaling state; and
enabling the line driver to actively drive the clock wire to the first voltage level when the clock signal is in the first signaling state and when the period of time has expired.

28. The storage medium of claim 26, wherein the feedback signal is provided by a line receiver coupled to the clock wire.

29. The storage medium of claim 25, wherein the code comprises instructions for:
using an enable signal derived from the clock signal to control enablement of the line driver when the master device is configured for a second mode of operation.

30. The storage medium of claim 25, wherein the code comprises instructions for:
closing a switch that couples the clock wire to a voltage source through the resistor when the master device is configured for the second mode of operation.
